(19) United States
(12) Patent Application Publication
(10) Pub. No.: US 2022/0414798 A1
(43) Pub. Date: Dec. 29, 2022

(54) APPARATUSES AND A SYSTEM FOR MONITORING OCCUPANCY AND ELECTRIC VEHICLE CHARGING ACTIVITY AT PARKING SPACES

(71) Applicant: James Penfold, Kittery, ME (US)

(72) Inventor: James Penfold, Kittery, ME (US)

(21) Appl. No.: 17/691,484

(22) Filed: Mar. 10, 2022

Related U.S. Application Data
(60) Provisional application No. 63/200,487, filed on Mar. 10, 2021.

(51) Int. Cl. G06Q 50/06

(52) U.S. Cl. CPC G06Q 50/06; B60L 53/68

(57) ABSTRACT

A system and method monitors occupancy and electric vehicle charging activity at parking spaces to optimize charging availability and to electric vehicles and parking/charging control systems using various obtained data, and the use of the data to compute and dynamically adjust parking regulations, charging time and resulting alerts to customers and facility operators, to improve the management of energy consumption and control and manage as well as increase parking/charging station utilization.

### CROSS-REFERENCE TO RELATED APPLICATION

This application claims priority from U.S. provisional patent application No. 63/200,487 filed on Mar. 10, 2021 entitled “APPARATUSES AND A SYSTEM FOR MONITORING OCCUPANCY AND ELECTRIC VEHICLE CHARGING ACTIVITY AT PARKING SPACES” which is incorporated fully herein by reference.

### FIELD OF THE INVENTION

The present invention relates to electrical vehicle charging and, more particularly, to devices and a system and method to monitor occupancy and electric vehicle charging activity at parking spaces to optimize charging availability and to electric vehicles and parking/charging control systems using various obtained data and the use of the data to compute and dynamically adjust parking regulations, charging time and resulting alerts, to improve the management of energy consumption and increase parking/charging station utilization.

### BACKGROUND OF THE INVENTION

The wide public adoption of electric vehicles (EVs) and plug-in hybrid electric vehicles (PHEVs) likely depends upon several factors. These factors include the development of a network of readily available charging spaces where owners of PHEVs and EVs can charge their vehicles when not being driven

Development of the market for EVs will focus on increasing the availability of parking spaces served by electric charging stations. As the number of EVs and PHEVs grows over time, the supply of electrified parking (EP) spaces for dedicated users will likely expand in combination with demand. During this transitionary period, it can be reasonably anticipated that supply of and demand for charging spaces will be frequently out of balance.

As demand for EP spaces grows, businesses will seek to serve the market by installing charging stations at parking spaces on both public and private property. The growth of this market, however, will likely be constrained by the competing demands of conventional vehicle owners for a limited supply of parking spaces. Conventional vehicle owners, otherwise known as Internal Combustion Engine (ICE) vehicles (ICE) drivers will likely object to the loss of available public parking spaces to EV and PHEV users unless those spaces are used as frequently as other parking spaces in the area and there is adequate parking space for ICE vehicles.

This will have many negative results. First, vehicle owners of ICE vehicles will occupy dedicated EP spaces. It will also result in EV owners using EV spaces and either: (i). Not plugging in at all; (ii). Plugging in, but not initiating a charge and delivering an active transfer of power to their vehicle; and (iii). Actively charging followed by the charging session ceasing and the vehicle occupying the space; (iv) Actively charging at a very low power and slow speed. All these situations will result in the reduced utilization of the

charging stations. Property owners will find it hard to offer sufficient balance of ICE and EV parking spaces resulting in them to invest more capital in charging equipment. Furthermore, property owners will find it very difficult to accurately allocate the appropriate balance of parking spaces for EVs and ICE vehicles either permanently or at any one time. Also, a building's electrical infrastructure capacity will be limited and allocating the finite energy between the EV charging stations and other building loads will be difficult to balance correctly. An imbalance will remain where a charging station needs to be allocated a certain amount of power, but in the case that there is an ICE vehicle blocking said charging station, this power can be reallocated to either other charging stations or the building loads. The other problem is that drivers expect a minimum charge rate (measured in kW or amperage) and
when all electric vehicle supply equipment (EVSE) are being used, there is no more power to share and the existing parking spaces with EVSE may not be able to dispense energy. Any parking regulation enforcement that requires a vehicle to be actively charging cannot compute that a vehicle is either plugged in waiting to receive a charge or is receiving a very low charge rate. Also, the need to accurately predict the availability of electric vehicle charging stations is very difficult to do accurately by manual methods and this will result in an imbalance. Also, there is no way for a property owner to configure a charging station to disconnect power or reduce it based on historical information and based on the parking regulations such as, but not limited to the amount of time a driver is allowed to actively charge their vehicle and leave it parked after the charging session. Also, there is no system to monitor the parking and charging activity in a parking space and integrate that with a charging network such as through a cloud-based API. Also, there is no way to integrate this information with a building management system and either reduce cease or manage the electrical load of to the charging station based on the current occupancy.

There are many deficiencies with current systems. Existing EVSE designs are only capable of monitoring charging sessions, not the complete activity of charging sessions and objects presence during the entire parking period. Property owner parking management personnel cannot reliably identify a battery electric vehicle (BEV) from a Plug in Hybrid Electric Vehicle (PHEV) from a Hybrid or Internal Combustion Engine vehicle (ICEV), as some makes and models of BEV, PHEV, Hybrid and ICEV mostly look identical to each other. Furthermore, some EVSE allows the driver to plug in the cord without initiating a charge session so the management will not be able to reliably recognize if a vehicle is actively charging. Property owners cannot accurately predict the appropriate balance of EV charging spaces allocated exclusively for EVs and they cannot allocate electrical loads between other

charging spaces and/or the building. The most sophisticated EVSE will use fees to deter an EV that has plugged in to unplug. However, they have no way of monitoring the parking space for all vehicles and deterring and alerting general parking violations. Systems that may shift, reduce or stop electrical load to an EVSE do not take into consideration the presence of an ICE vehicle or EV that is not charging to allocate electrical load.

As can be seen, there is a need for a device, system and method to monitor occupancy and electric vehicle charging activity at respective parking spaces to optimize charging availability.

### BRIEF DESCRIPTION OF THE DRAWINGS

FIGS. 1A and 1B are schematic diagrams of one embodiment of the present invention, shown in use with a parking space;

FIG. 2 is a block diagram of one embodiment of the system of the present invention; and

FIGS. 3A-3B and 4-6 are flow charts describing one embodiment of the method carried out by the system according to one embodiment of the present invention.

### DETAILED DESCRIPTION OF THE INVENTION

The following detailed description is of the best currently contemplated modes of carrying out exemplary embodiments of the present invention. The description is not to be taken in a limiting sense but is made merely for the purpose of illustrating the general principles of the present invention, since the scope of the present invention is best defined by the appended claims.

Broadly, an embodiment of the present invention provides an apparatus and system for monitoring occupancy and electric vehicle charging activity at respective parking spaces to optimize charging availability. A system in accordance with the present invention detects objects in the parking area through an inductive traffic loop, sonar sensor, infrared sensor, video camera or other object sensing technology and combines this data with electrical current transformers that are attached to the circuits of the electrical vehicle charge supply equipment (EVSE). The system uses the combined data to create a report and alert. This can be used to minimize parking violations and, in general, maximize the utilization of the electrified parking spot for active EV charging sessions.

Furthermore, there currently is no way for a driver of either an EV or ICE vehicle to park in a space with an EVSE and notify the EVSE that they are permitted to park without actively charging or at a minimum rate of energy flow. To prevent the device from creating an alert of a parking regulation violation, the system described herein allows them to communicate to the device. Examples include a radio-frequency identification (RFID) card,

phone app etc. that they are permitted to park, and the system will not create an alert. This could be particularly useful where drivers have permits issued that give them privileges to allow them to park in any parking space and with either an EV or ICE vehicle. The device and system of the present invention monitors the total number of EVSE in the parking lot
with occupied spaces and energy rate of all EVSE that are actively charging. By computing the activity in each parking spot, the system can send out alerts for each space according to the compliance with the parking regulations. For example, where normally a “grace” period is provided for 30 minutes after an active 2-hour charge session, and all electrified parking spaces in the lot are occupied, to encourage a driver to move their vehicle, the grace period before sending an alert to the parking enforcement manager is sent without such a “grace” period. Also, based on the time of day and utilization rate of the EV parking spaces, the device can be programmed to send higher priority alerts based on if it is an ICE vehicle or an EV that doesn't have an active charging session or the amount of time a vehicle remains parked after an active charge session.

The device and system advantageously can use the data to programmatically change the assignment of parking spaces from either restricted to EV only, ICE vehicle only or a mix of the two by alerting drivers through methods such as a digital display or a phone app notification. The device and system can also use the data to programmatically shift electrical loads depending on for example the time of day, number of parking spaces occupied

by either EV or ICE vehicle, low energy pricing, clean energy availability or if vehicles are exporting energy to the grid (V2G)

Current EVSE can detect when the vehicle is plugged in and either actively charging or not, but they are not able to detect the presence of any vehicle that is simply occupying the space. Furthermore, they cannot discern if a vehicle has been unplugged and remains in the space after an active charge session. The system, in accordance with the present, is hardware agnostic and can be retrofitted to any EVSE regardless of its functionality. The system is designed to send alerts that are quick and easy for all untrained personnel to readily recognize and act upon. Unlike other systems, this can be retrofitted to a charging equipment circuit as a standalone device. It can take the information gained over time about the presence of EVs and ICE vehicles in a parking space and algorithmically calculate the correct balance of EV and ICE vehicle parking spaces. It can also calculate whether to allocate available electrical infrastructure power to other charging stations or the building.

Prior to the present invention, there was no other device available where it can be configured to either stop charging or modify the type of alert based on the historical time of week or day. Further, there was no device that combines the data obtained from the charge session with the historical and current occupancy of all the parking spaces with EVSE and computes the type of alert and time of day to send this to the parking enforcement manager. Finally, there was no device that combines this information with a charging network such as with a cloud-based API.

As mentioned, the system is hardware agnostic, so it can be installed in combination with any EVSE make, model or technology so the parking personnel will have a consistent and easy to understand way to reliably monitor parking regulation compliance without needing to learn the intricacies of how each type, make and model of EVSE interacts with each type, make and model of vehicle. Furthermore, the system provides data that the parking management can analyze about parking session and charging activity to enable them to increase parking regulation enforcement, improve regulations, improve communication of the regulations to drivers and in general maximize the utilization of the EPs. It can allocate power to either other EV chargers or building loads based on the parking information. For example, a parking space that is allocated with a certain amperage does not need to reserve that electrical capacity if the space has an ICE vehicle occupying it. This can be allocated to another space or the building. It also allows a parking manager to either manually or automatically, through artificial intelligence, modify alerts and either increase or reduce enforcement of regulations depending on a number of factors including such as time of day/week/year total parking spaces occupied, total electrified parking spots occupied, total EVs actively charging, total electrical load and peak utility rate per kilowatt of demand charge and kilowatt hours of electricity, vehicles exporting energy (V2G) and clean energy availability.

Another improvement on the prior art is that at times there will be low, free or negatively priced energy and to encourage the consumption of this, the device can signal to drivers and management that the parking regulations have changed and extra power in kilowatts or flow in kilowatt-hours (kWh) and time charging is available, e.g., a parking space may have a 2 hour limit from 9 am to 5 pm during shoulder peak utility rates, a 1 hour limit from 5 pm-7 pm peak hours and an unlimited parking time from 7 pm-9 am when demand on the grid is low and there is limited demand for parking spaces. In general, the device will use an algorithm to compute when to modify and alert entities of parking and charging violations in the electrified parking spots. The sensor, controller, light emitting diodes (LEDs), and power supply are essential aspects of the present invention. Furthermore, at times during high energy usage, a vehicle that is capable of exporting energy may be incentivized to park for longer than regulations normally as the vehicle is lessoning the load on the building.

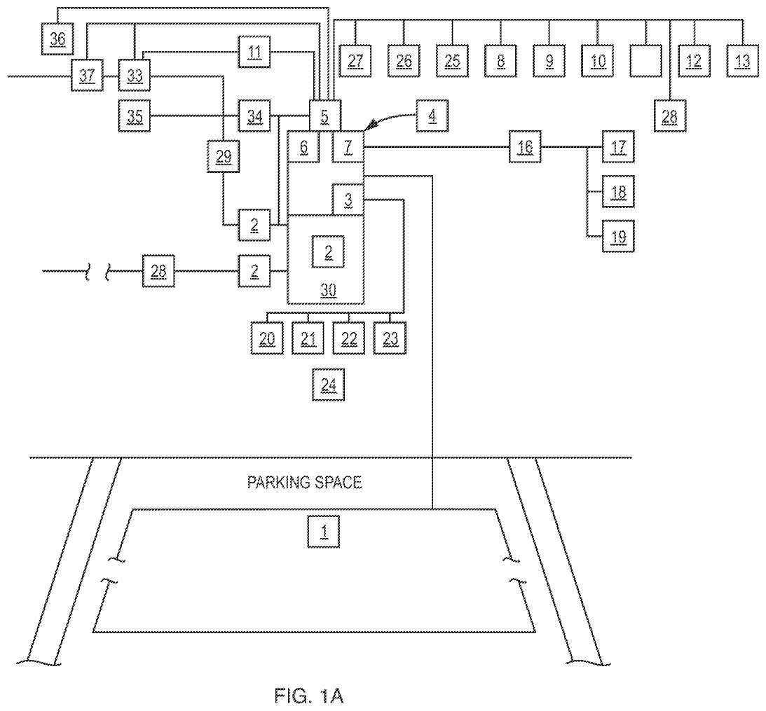

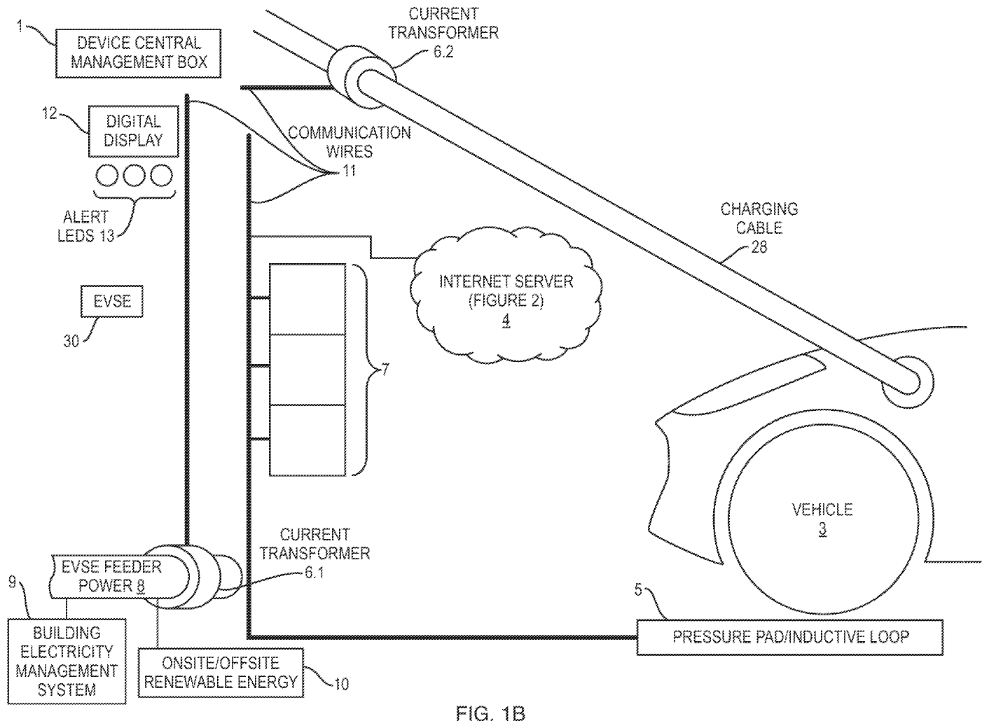

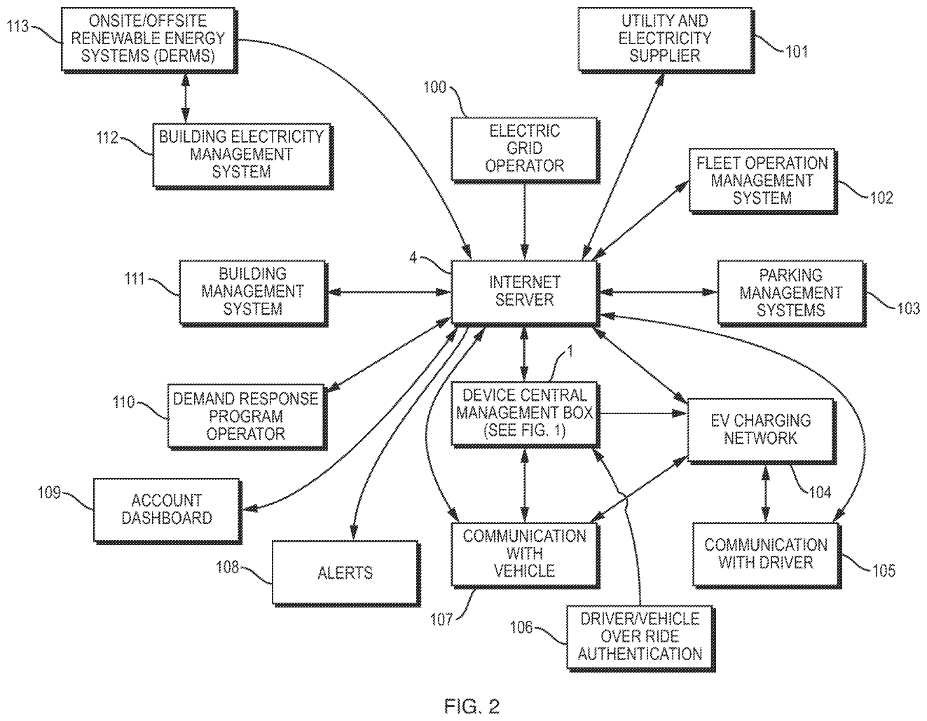

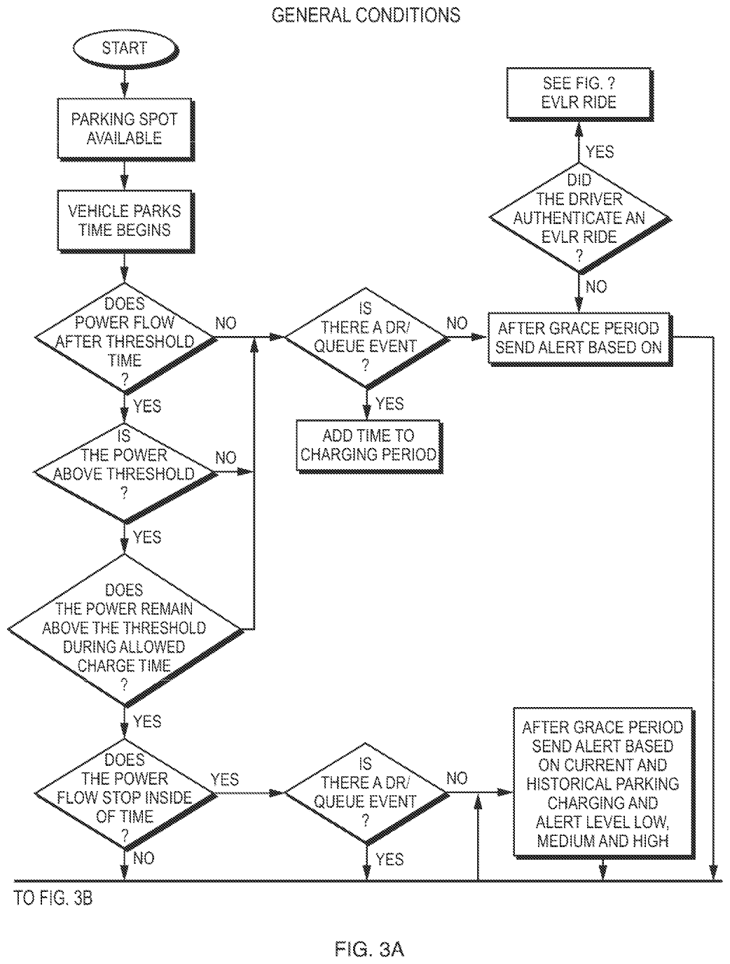

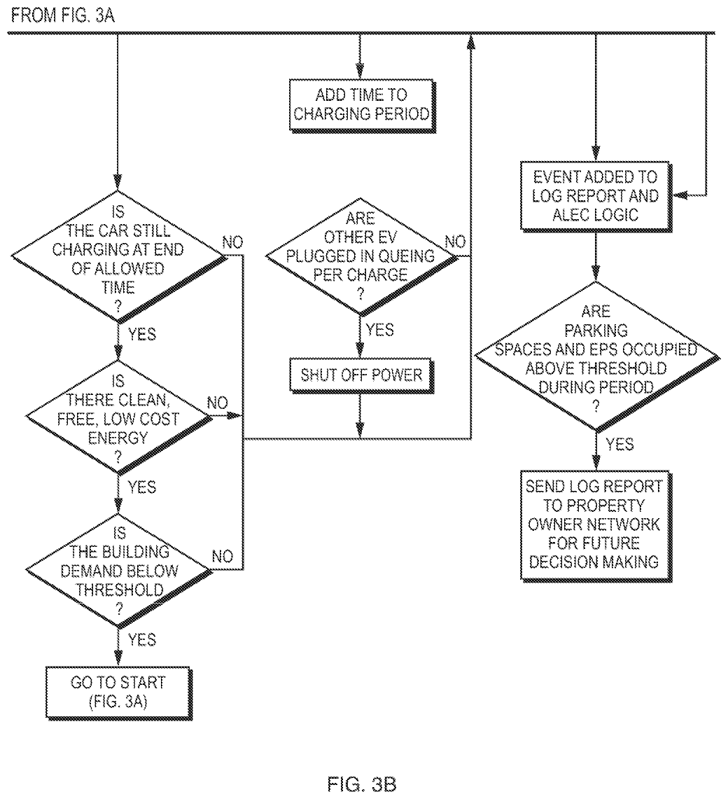

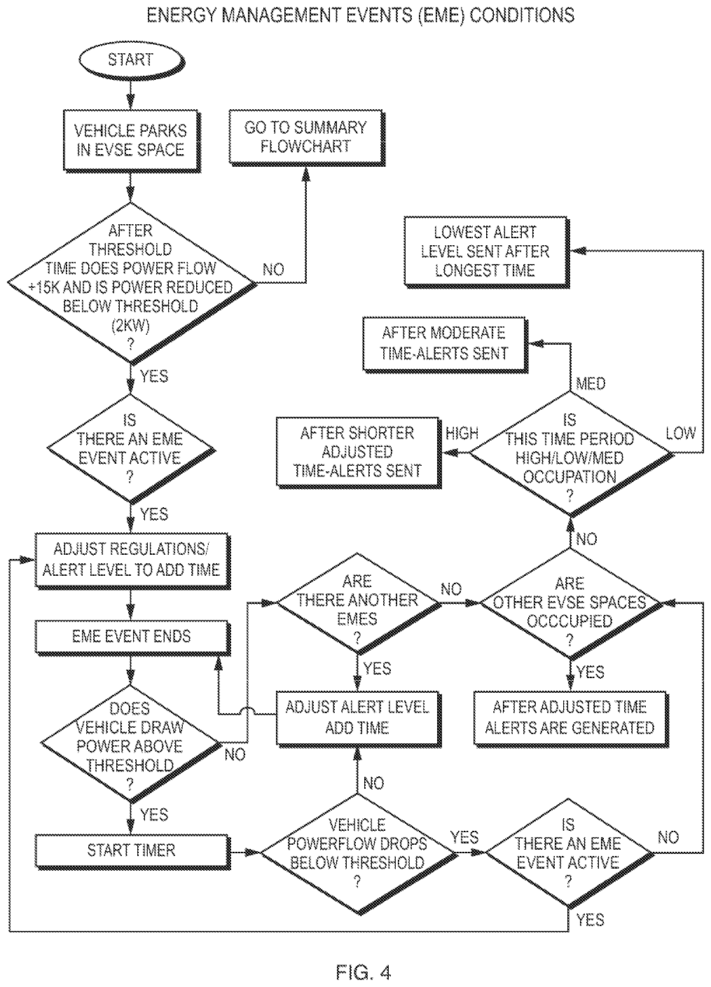

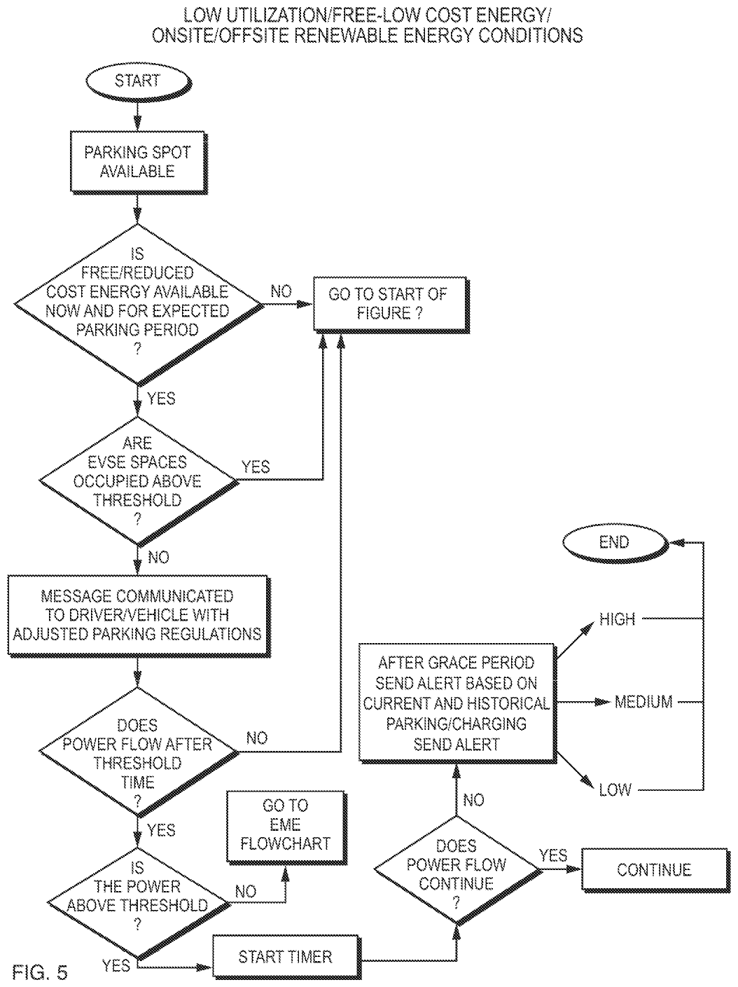

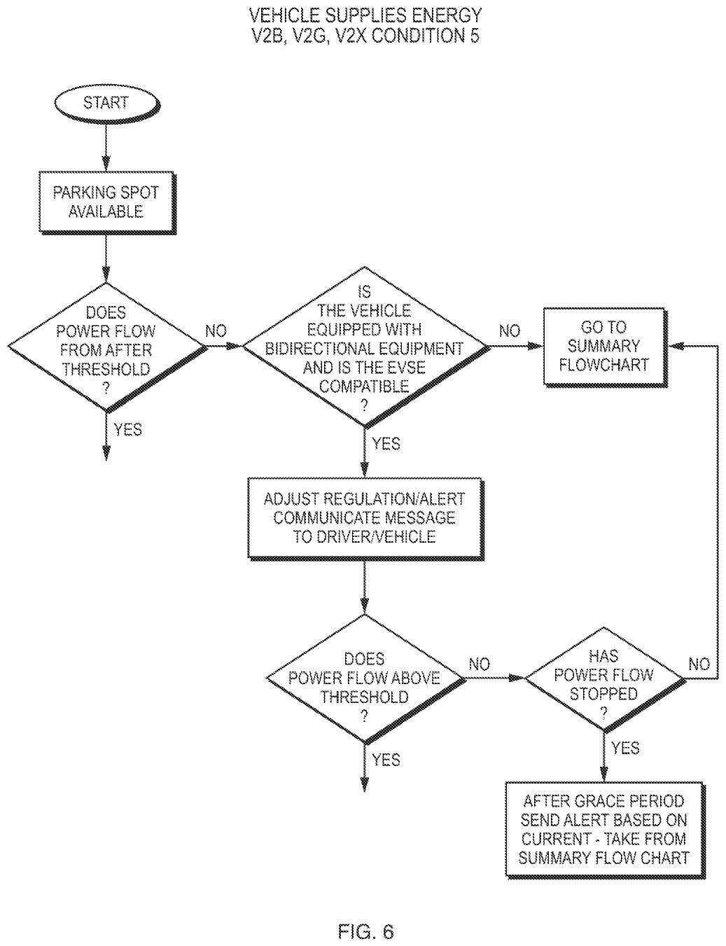

Referring now to FIG. 1, a sensor/inductive loop (1) is placed on or under the surface of the parking space (as noted in FIG. 1) and is connected by wire to a control box (4), and/or a sonar sensor (20) is connected by the wire to the control box (4), and/or an infrared sensor (21) is connected to the wire to the control box (4), and/or a laser sensor (22) and/or a radar sensor (23) and/or a video camera (24), and combinations thereof, is/are connected to the wire to the control box (4). One or more current transformers (2) are connected to the electrical supply wire(s) (29) of an EVSE (30) and/or the charge cable (28). The current transformers (2) are then connected to the device control box (4). The device control box (4) is connected to a power supply cord (16) and either plugged into or hardwired into an electrical outlet/wires (17) or photovoltaic supply (18) or battery supply (19), and combinations thereof. The control box is connected with LEDs (6) and an LCD Display (7).

Also, a modem (5) is provided that can communicate with any or all of the following and display data via a website dashboard (8), mobile phone application (9), email and/or text message (10), parking management software (11), parking management hardware (12), Parking management personnel mobile enforcement devices, building management software (13), building management hardware (32), power management software, power management hardware (33), EVSE (30) EV charging network/software (34), fleet management software (26), fleet management hardware (27), and the system cloud server (36) with API. The modem (5) will also communicate with a power management software (11) and hardware (14) (e.g., power management controllers) that can disconnect or reduce power to the EVSE (30). The server (36) will communicate via the cloud the availability of reduced-price energy and/or clean energy with the device.

The sensor (1), as mentioned, may be an inductive traffic loop that is placed under the parking surface with wires that connect it to the control box, or a sonar sensor (20) mounted in a position in front of the EVSE (30) and connected by wire or wirelessly to the control box. The current transformers (2) that are attached to a circuit that will supply electricity during an active charge session. This can either be within the EVSE or an outside feeder. The circuit board (3) is housed with the control box (4) and monitors the inputs and outputs from the sensors (traffic loop, sonar, infrared, laser, radar, camera etc.) and current transformers (2). It is also connected to the LEDs (6) and LCD display (7). The circuit board

(3) further computes the configured parameters of the parking time and active charging session and sends a signal to the LEDs (6) and LCD display (7).

The sensors (traffic loop, sonar, infrared, laser, radar, camera etc.) identify when a vehicle is present and start a timer within the controller, the current transformers identify when (if at all) a charge session starts and stops. The information is computed and displayed on the LCD display screen, LEDs and communicated to a cloud-based server through the modem. The data may then be displayed on a website dashboard, mobile app, parking management software, EVSE hardware and software, building management software, email, phone, or text alerts, and combinations thereof. As potential reconfigurations of the embodiment herein described, different (i) sensors, (ii) central alerts, (iii) integrations with parking meters and EVSE, (iv) integrations with video monitoring, (v) and inputs from the EVSE software to the server, as herein described, to monitor charge sessions without CTs may be used in accordance with the present invention.

To make, the control box is mounted so that is easily visible to the parking management and driver. The sensors are connected to the control box. The current transformers are connected to the EVSE charging circuit wires, with the other end of the wires being connected to the control box Finally, the power supply is connected to the control box and turned on.

To use embodiments of the present invention, when a vehicle enters the parking space, the inductive loop (1) and/or other sensors (previously described) first detect the presence of a large object. These sensors are calibrated so that it is assumed that the object is a parked vehicle. A signal is sent to the control box (4) and this starts a timer. Meanwhile, the control box (4) monitors the energy flow of the EVSE charging cable (28) and/or the EVSE electricity feeder circuit (29) through the Current transformer/s (2). The control box (4) is pre-configured by the property owner to send alerts based on certain performance parameters of including, but not limited to: total time elapsed, total time actively charging, total time elapsed since cessation of active charging, occupancy, presence of energy in kWh, kW, amperage, and voltage.

When the control box (4) algorithm matches the performance to these criteria, an alert is sent through either a wired or wireless signal to any one or more of the following:
The device cloud based server;
LED lights (6) will activate in different colors and in blinking or steady state;
LCD Display (7) will show a message showing details to the driver and property management;
Internet dashboard (8);
   Mobile application (9);
   Email and/or text alert (10);
   Parking management software (11);
   Parking management hardware (12);
Building management software (13);
   Building management hardware (32);
   Electricity management software (14);
   Electricity management hardware (33);
   EV charging network software (34);
   EVSE (30)
   Parking enforcement personnel mobile devices (25);
   Commercial fleet management software (26); and
   Commercial fleet management hardware (27).

The visual alerts on the LEDs (6) and/or LCD display (7) can be used by the property owner to encourage compliance with the parking regulations or guidelines by either leaving a memo or citation on the vehicle, towing the vehicle away, taking note of the license plate and recording for future use. The data transmitted to parking management software (11) and hardware (12) can be used to alert parking enforcement officers and/or be used to calculate a parking fee that is assessed at the time of departure from the property. The data transmitted to fleet management software (26) and hardware (27) can be used to monitor charging activity and assist with optimizing the turnover of vehicles being charged. The data transmitted to the parking enforcement officer's mobile device (25) can be used in generating

citations and warnings. The data can also be used by building management hardware (32) and software (13) to monitor usage and intelligently manage electricity in other parts of the building also by placing switchgear and controllers (33) (or electricity management equipment) on the EVSE power supply/feeder circuit (29) such that electricity flow can be reduced or disconnected. The data can be used by EV charging networks (34) to monitor, reduce and disconnect charge sessions through a connection to the EVSE (30). The system and data produced by the system may also be used in combination with a charging and parking reservation system (35). Further, the data can be used to run algorithms that can predict the optimal balance of EV charging space to ICE vehicles spaces. The property owner may configure the system to match their parking regulations and prioritize when to offer “grace” times either manually input or automatically calculated using artificial intelligence incorporated with the system.

The invention features, in one embodiment, a system that adjusts parking control and management as well as alerts/notices to vehicle operators and well as parking facility management for the parking of vehicles in a parking spot that has access to charging equipment utilizing input data from various factors including parking activity; the energy or lack thereof supplied to the parked vehicle and associated external energy supply. The system computes data as part of the configuration and calculation in adjusting the parking/charging regulations for any particular vehicle/parking/charging spot. Information utilized by the system to provide these calculations and adjustments include both historical as well as current data inputs.

The system receives energy usage data from, for example, CTs (Current transformers) that are attached to EVSE (Electric Vehicle Supply Equipment) circuits and adjusts the regulations/guidelines based on this information. Other methods of monitoring energy data are contemplated. The system receives energy data from the EVSE hardware via a hardwire or software connection and adjusts the regulations/guidelines based on this information. The system may also be configured to receive energy flow data from the EVSE operating software via an internet cloud server and may adjust the regulations/guidelines based on this information.

The system according to one embodiment of the invention is configured to receive energy flow data from a building energy usage device and subsequently adjust/controls the charging/parking regulations/guidelines based on this information. Information considered by the system of the invention and adjusts the regulations/guidelines based on this information includes, but is not limited to “calendar and time of day” data; energy management events including, for example, “demand response/curtailment” data; data obtained from input signals from outside parties that manage demand response programs; “peak shaving” data; data from the EVSE or charging station network operator or building/parking system operator; “charge queuing” data; “load balancing” data; “utility time of use rates” data; “renewable energy” data; electrical grid operators and third party program operators; “self-consumption energy” i.e. energy produced either on site or offsite data; data that energy is free or negatively priced; “building electricity usage” data; “over-ride” data; data obtained through software communication that the vehicle is eligible to park in the parking space regardless of the regulations (this can be through the use of the vehicle owner configuring a program that sends a signal when the vehicle is plugged in or the driver communicates this to the device with an RFID card or smartphone for example; “battery state of charge” data; “parking occupancy” data; data from vehicle and fleet operation management systems.

Such a system as claimed and disclosed should also compute and provide parking/charging “grace periods” to send alerts to the user and charging/parking facility operator. The system may also determine the parking and charging time policy and dynamically adjust the type of enforcement alerts and when they are sent.

Other data that may be considered may include but is not limited to historic data compared with current data for the same Time: Year, Month, Day, Hour, Minute and second for, one or more factors including Quantity of total parking spaces available; Quantity of parking spaces available with EVSE (Electric Vehicle Supply Equipment); Quantity of vehicles entering the parking facility; Percentage of all parking spaces occupied; Percentage of regular parking spaces occupied; Percentage of EVSE parking spaces occupied; Presence of a Special events that creates an abnormal quantity of vehicles; EVSE maximum amperage, kilowatts, voltage; EVSE current amperage, kilowatts, KVA, voltage; Total maximum amperage of All EVSE; Transaction fee paid (i.e. did the driver pay a premium to charge and leave the vehicle for an extended period?) Is an EV plugged in? Is an EV charging? Is an EV still plugged in following an active charging session? has the vehicle moved from the parking space since the charging session ended and was unplugged? Has another driver registered made a reservation or are they waiting in line for the EVSE; Does the driver have a special privilege to park and charge for extended periods e.g. are they an employee or guest? Cost of energy measured in kilowatts (KW), kilowatt hours (KWH) and kilovars (KVA); Total quantity of renewable energy generation (solar, wind,) supplying the grid in Megawatts (MW); Percentage of energy generation on the grid from renewable energy; Quantity of renewable energy generation supplied locally e.g. Roof top solar; Presence of bidirectional (V2G) paired EV and EVSE; Total and Maximum and minimum KW and Amps and KWH, KW transferred by V2G; Demand response events called by the utility such as load reduction; Does the utility account offer a financial incentive program to reduce loads at certain times of Year or day or certain times of the day? and Input from APIs from Grid operator, charging network, third party aggregators of energy devices.

Other data which may be considered includes, but also not limited to, Driver ID#; Charging network; charging/parking station address including street, city, state, zip code; Station time zone; charging e; charging plug ID; charging session ID; date, and start/end times; total time plugged in; total time spent charging; total energy dispensed (kWh); Total transaction fee; Connector type; Max power output (kW); and max amperage (A).

The present invention has been described in terms of exemplary embodiments solely for the purpose of illustration. Persons skilled in the art will recognize from this description that the invention is not limited to the embodiments described but may be practiced with modifications and alterations limited only by the spirit and scope of the appended and allowed claims.

What is claimed is:

1. A system and method for monitoring and controlling occupancy and electric vehicle charging activity at respective parking spaces to optimize charging availability, comprising: a monitoring system configured for adjusting parking control and management as well as alerts/notices to vehicle operators as well as parking facility management for the parking of vehicles in a parking spot that has access to and connected with electric charging equipment, said monitoring system is configured for receiving both historical as well as current input data of varying types from various sources, and responsive to said input data, for calculating and adjusting the parking/charging regulations for any particular vehicle/parking/charging spot and for adjusting parking and charging regulations/guidelines based on this data and for providing alerts to a vehicle operator as well as parking/charging operator/manager.
